(19) United States
(12) Patent Application Publication
(10) Pub. No.: US 2024/0025538 A1
(43) Pub. Date: Jan. 25, 2024

(54) LIVE SYSTEM WITH SPLASH GUARD

(71) Applicant: Textron Innovations Inc., Providence, RI (US)

(72) Inventors: Gary Miller, North Richland Hills, TX (US); Amarjit Olenchery Kizhakkepat, Fort Worth, TX (US); Peter Romano, Fort Worth, TX (US); Norman Craig Jordan, Springtown, TX (US); Shahryar Fotovati, Frisco, TX (US); Matthew Wade Hendricks, Grand Prairie, TX (US)

(73) Assignee: Textron Innovations Inc., Providence, RI (US)

(21) Appl. No.: 17/869,841

(22) Filed: Jul. 21, 2022

(51) Int. Cl. B64C 27/00; B64C 27/12; F16F 7/10

(52) U.S. Cl. CPC B64C 27/001; B64C 27/12; F16F 7/1034; B64C 2027/002; F16F 2222/08; F16F 2230/0052

(57) ABSTRACT

An aircraft includes a frame, a transmission, and a liquid inertia vibration elimination (“LIVE”) system coupled between the frame and the transmission. The LIVE system is configured to attenuate communication of vibrations from the transmission to the frame. The LIVE system includes a first liquid zone, a second liquid zone, a plug at least partially segregating the first liquid zone from the second liquid zone, and the plug has an aperture in fluid communication with the first liquid zone and the second liquid zone. A splash guard is disposed within the second liquid zone and offset from the plug.

### BACKGROUND

The present disclosure relates in general to vibration control. More specifically, the present disclosure relates to a novel compact design of an apparatus for isolating mechanical vibrations in structures or bodies that are subject to harmonic or oscillating displacements or forces. The apparatus of the present disclosure is well suited for use in the field of aircraft, in particular, helicopters and other rotary wing aircraft.

For many years, effort has been directed toward the design of an apparatus for isolating a vibrating body from transmitting its vibrations to another body. Such apparatuses are useful in a variety of technical fields in which it is desirable to isolate the vibration of an oscillating or vibrating device, such as an engine, from the remainder of the structure. Typical vibration isolation and attenuation devices (“isolators”) employ various combinations of the mechanical system elements (springs and mass) to adjust the frequency response characteristics of the overall system to achieve acceptable levels of vibration in the structures of interest in the system. One field in which these isolators find a great deal of use is in aircraft, wherein vibration-isolation systems are utilized to isolate the fuselage or other portions of an aircraft from mechanical vibrations, such as harmonic vibrations, which are associated with the propulsion system, and which arise from the engine, transmission, and propellers or rotors of the aircraft.

Vibration isolators are distinguishable from damping devices in the prior art that are erroneously referred to as “isolators.” A simple force equation for vibration is set forth as follows:

F=m\ddot{x}+c\dot{x}+kx

A vibration isolator utilizes inertial forces (m\ddot{x}) to cancel elastic forces (kx). On the other hand, a damping device is concerned with utilizing dissipative effects (c\dot{x}) to remove energy from a vibrating system.

One important engineering objective during the design of an aircraft vibration-isolation system is to minimize the length, weight, and overall size including cross-section of the isolation device. This is a primary objective of all engineering efforts relating to aircraft. It is especially important in the design and manufacture of helicopters and other rotary wing aircraft, such as tilt rotor aircraft, which are required to hover against the dead weight of the aircraft, and which are, thus, somewhat constrained in their payload in comparison with fixed-wing aircraft.

Another important engineering objective during the design of vibration-isolation systems is the conservation of the engineering resources that have been expended in the design of other aspects of the aircraft or in the vibration-isolation system. In other words, it is an important industry objective to make incremental improvements in the performance of vibration isolation systems which do not require radical re-engineering or complete redesign of all the components which are present in the existing vibration-isolation systems.

A marked departure in the field of vibration isolation, particularly as applied to aircraft and helicopters is disclosed in U.S. Pat. No. 4,236,607, titled “Vibration Suppression System,” issued on Dec. 2, 1980, to Halwes, et al. (“Halwes '607”). Halwes '607 is incorporated herein by reference. Halwes '607 discloses a vibration isolator, in which a dense, low-viscosity fluid is used as the “tuning” mass to counterbalance, or cancel, oscillating forces transmitted through the isolator. This isolator employs the principle that the acceleration of an oscillating mass is 180° out of phase with its displacement.

In Halwes '607, it was recognized that the inertial characteristics of a dense, low-viscosity fluid, combined with a hydraulic advantage resulting from a piston arrangement, could harness the out-of-phase acceleration to generate counter-balancing forces to attenuate or cancel vibration. Halwes '607 provided a much more compact, reliable, and efficient isolator than was provided in the prior art. The original dense, low-viscosity fluid contemplated by Halwes '607 was mercury, which is toxic and highly corrosive.

Since Halwes' early invention, much of the effort in this area has been directed toward replacing mercury as a fluid or to varying the dynamic response of a single isolator to attenuate differing vibration modes. An example of the latter is found in U.S. Pat. No. 5,439,082, titled “Hydraulic Inertial Vibration Isolator,” issued on Aug. 8, 1995, to McKeown, et al. (“McKeown '082”). McKeown '082 is incorporated herein by reference. An example of the former is found in U.S. Pat. No. 6,022,600, titled “High-Temperature Fluid Mounting”, issued on Feb. 8, 2000, to Schmidt et al. (“Schmidt '600”). Schmidt '600 is incorporated herein by reference.

Several factors affect the performance and characteristics of the Halwes-type isolator, including the density and viscosity of the fluid employed, the relative dimensions of components of the isolator, and the like. One improvement in the design of such isolators is disclosed in U.S. Pat. No. 6,009,983, titled “Method and Apparatus for Improved Vibration Isolation,” issued on Jan. 4, 2000, to Stamps et al. (“Stamps '983”). In Stamps '983, a compound radius at each end of the tuning port was employed to provide a marked improvement in the performance of the isolator. Stamps '983 is incorporated herein by reference.

While the above describes great strides in providing vibration isolation systems, there is still a need for vibration isolation systems with improved ability to reduce mixing of liquid and gas working fluid components.

### BRIEF DESCRIPTION OF THE DRAWINGS

FIG. 1 is a side view of a helicopter including a liquid inertia vibration elimination (“LIVE”) system according to an embodiment of this disclosure.

FIG. 2 is an oblique view of a portion of the helicopter of FIG. 1 showing the LIVE system.

FIG. 3 is an oblique view of a portion of the helicopter of FIG. 1 showing the LIVE system in greater detail.

FIG. 4 is an oblique side view of the LIVE systems of FIGS. 1-3.

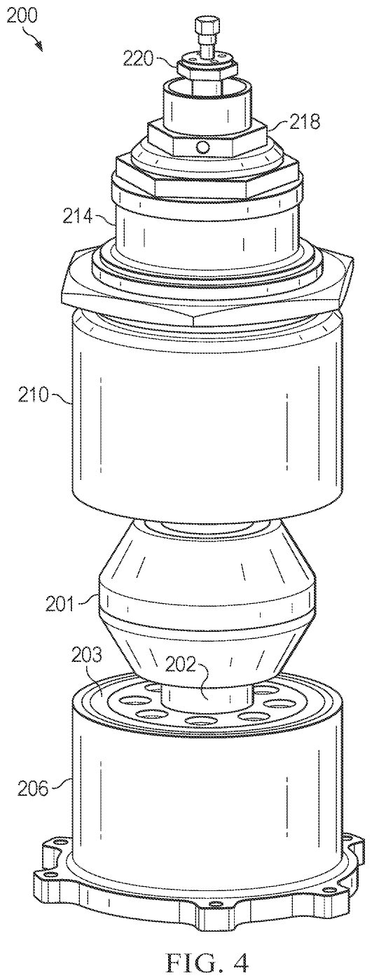

FIG. 5 is a side cutaway view of the LIVE systems of FIG. 4.

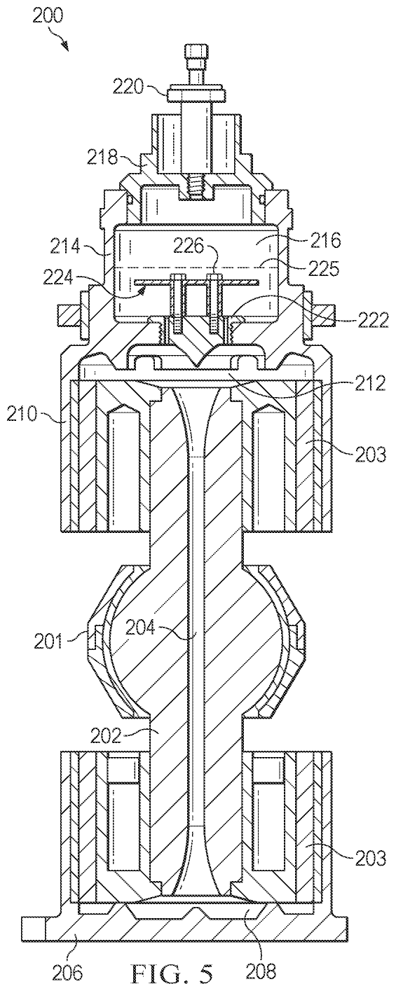

FIG. 6 is an oblique partial cutaway side view of the LIVE system of FIG. 4.

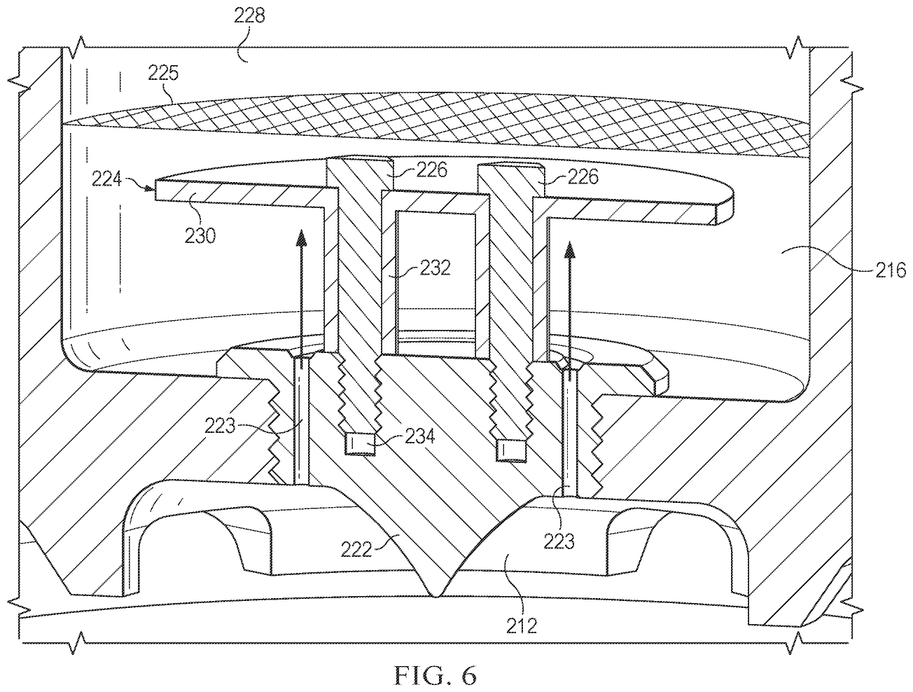

FIG. 7 is a chart showing frequency response of the LIVE system of FIG. 4 as compared to prior art LIVE systems.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure provides a liquid inertia vibration elimination (“LIVE”) system that provides reduced intermingling of liquid and gas working fluids within the LIVE system. As will be discussed, a splash guard disposed between a liquid transport orifice and a liquid-gas interface prevents gas from being ingested into liquid of the LIVE system from an accumulator as well as prevents fluid from escaping into an otherwise gaseous internal space of the accumulator.

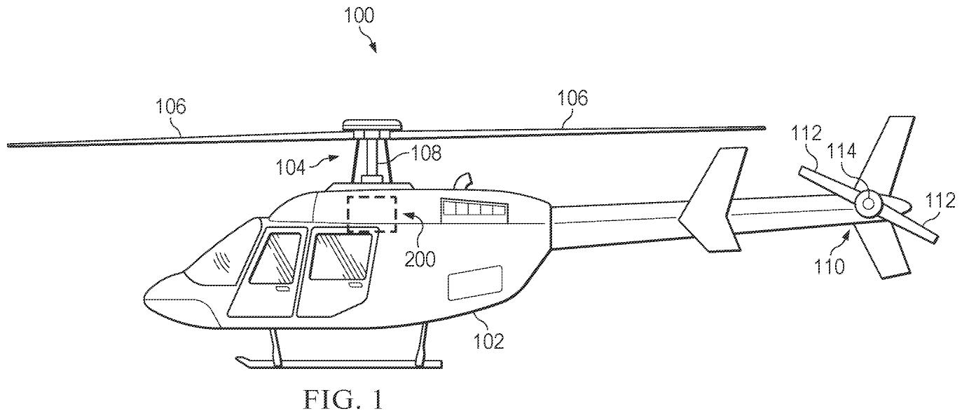

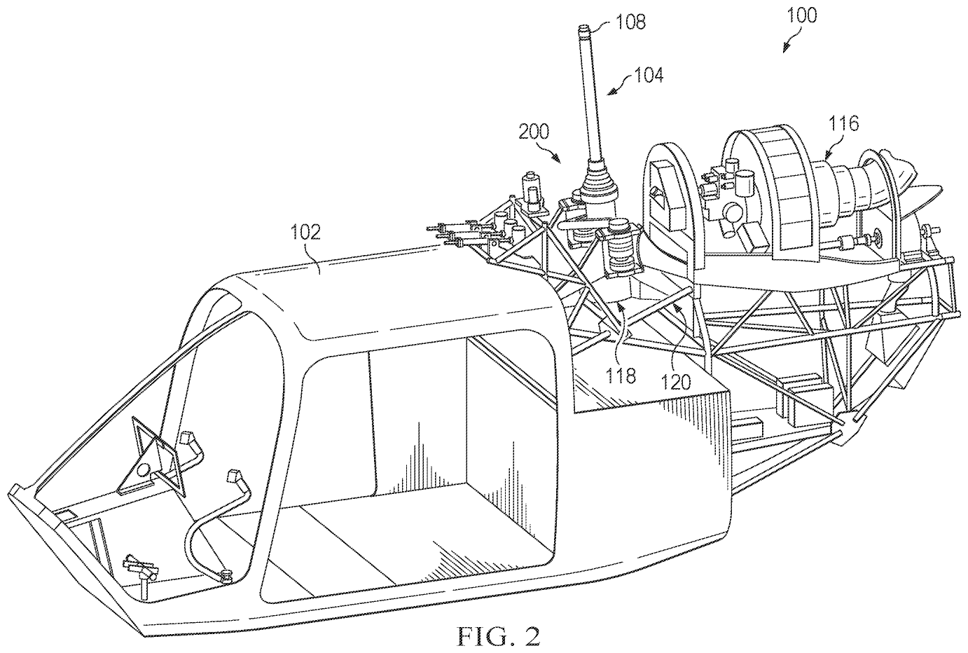

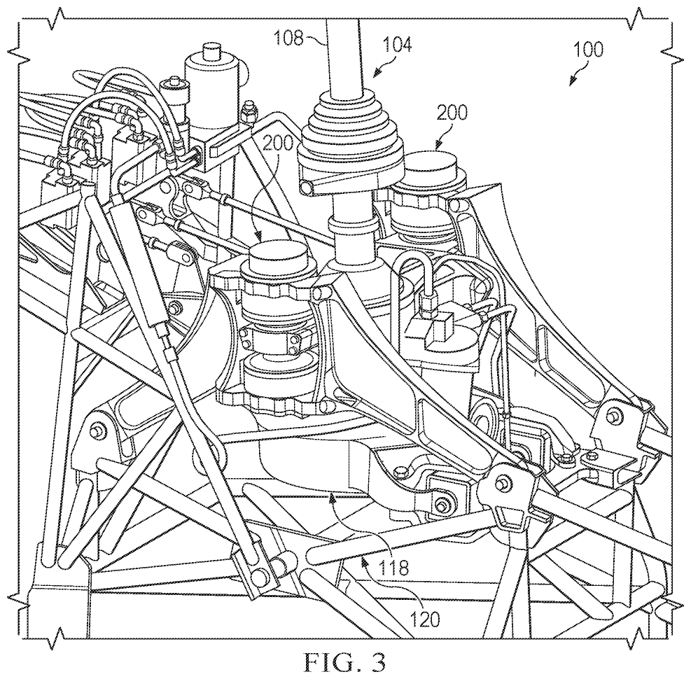

Referring now to FIGS. 1-3 in the drawings, a helicopter 100 according to the present disclosure is illustrated. Helicopter 100 comprises a fuselage 102 and a main rotor assembly 104, including main rotor blades 106 and a main rotor shaft 108. Helicopter 100 comprises a tail rotor assembly 110, including tail rotor blades 112 and a tail rotor shaft 114. Main rotor blades 106 generally rotate about a vertical axis of main rotor shaft 108. Tail rotor blades 112 generally rotate about a lateral axis of tail rotor shaft 114. Helicopter 100 further comprises two LIVE systems 200 according to the present disclosure for isolating fuselage 102 or other portions of helicopter 100 from mechanical vibrations, such as harmonic vibrations, which are associated with the propulsion system and which can arise from an engine 116, transmission 118, and rotor assemblies 104, 110 of helicopter 100.

Transmission 118 is suspended by two LIVE systems 200 that connect to an internal frame 120 of helicopter 100. More specifically, a bridge beam and a complementary bridge cap are used to capture and connect a spherical center bearing 201 of LIVE system 200 to transmission 118. Spherical center bearing 201 generally receives a piston 202 through a central passage of spherical center bearing 201. LIVE system 200 is further connected to internal frame 120 using a three piece assembly comprising a central bearing housing configured to receive two journal bearings 203 of each LIVE system 200. Spherical center bearing 201 provides pitch compliance for transmission 118 while journal bearings 203 provide vertical compliance.

In this embodiment, LIVE systems 200 are passive systems that comprise a fluid path that extends generally centrally through a central axis of piston 202. More specifically, LIVE systems 200 comprise a fluid path comprising at least a central port 204 of the piston 202, interior reservoir 208 of a lower end cap 206, and interior reservoir 212 of an upper end cap 210. An accumulator 214 is attached to upper end cap 210 and at least partially forms an accumulator interior space 216 that is at least partially segregated from the interior reservoir 212 by plug 222 having apertures 223 therethrough. In this embodiment, accumulator interior space 216 is further defined by an accumulator cap 218 and a fill valve gauge 220.

In operation, liquid is alternatingly forced from interior reservoir 212 to accumulator interior space 216 through apertures 223 and from accumulator interior space 216 to interior reservoir 212 through apertures 223. Importantly, LIVE system 200 further comprises a splash guard 224 that interferes with fluid jets and prevents liquid from moving beyond a liquid-gas interface 225 into a gas pressurized zone 228. Similarly, splash guard 224 prevents gas from being sucked from the gas pressurized zone 228 into the interior reservoir 212 via apertures 223.

Splash guard 224 comprises a platelike obstruction disc 230 that provides the above-described interference to high speed jet-like axial fluid motion. The obstruction disc 230 is further configured to have mount tubes 232 that extend axially and receive mounting bolts 226 therethrough to selectively retain the splash guard 224 relative to the plug 222. Mounting bolts 226 are also received by mount holes 234 of plug 222 while a head of the bolts 226 are sized to not fit through a portion of mount tubes 232. Accordingly, splash guard 224 is selectively removable from plug 222.

During operation of LIVE systems 200, the introduction of a force into piston 202 translates piston 202 relative to upper end cap 210 and lower end cap 206. Such a displacement of piston 202 forces tuning fluid that is disposed within the fluid flow path to move through central port 204 in the opposite direction of the displacement of piston 202. Such a movement of tuning fluid produces an inertial force that cancels, or isolates, the force from piston 202. During typical operation, the force imparted on piston 202 is oscillatory; therefore, the inertial force of the tuning fluid is also oscillatory, the oscillation being at a discrete frequency, i.e., isolation frequency.

While the LIVE systems 200 are described above as being utilized in a helicopter 100, the LIVE systems 200 can alternatively be utilized in any vehicle subject to large oscillatory forces at one discrete frequency, or a relatively narrow band of frequencies. For example, vehicles incorporating rotating machinery operating at one or more fixed speeds or speeds that vary across a relatively narrow range of speeds can utilize LIVE systems 200 to isolate vibration.

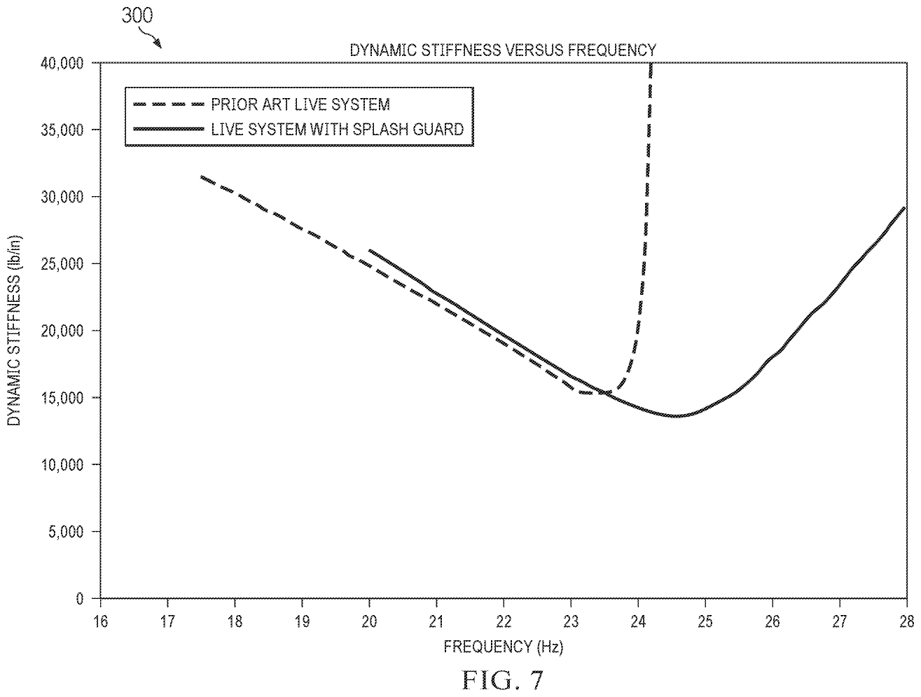

Referring now to FIG. 7, a chart 300 includes a plot of dynamic stiffness versus frequency of both a prior art LIVE system that utilizes a conventional cap attached to a plug, shown as curve 302, and a plot of dynamic stiffness versus frequency of the LIVE system 200, shown as curve 304, that incorporates use of splash guard 224 attached to plug 222 instead of the conventional cap having apertures therethrough. Dynamic stiffness testing of a prior art LIVE system exhibited a steep rise during endurance testing, indicating a transition to an undesirable damper-like behavior. As shown by curve 304, the damper-like behavior is not exhibited by LIVE system 200, in part because splash guard 224 prevents high velocity jet flows of liquid from breaking the liquid-gas interface 225 and prevents buildup of gas in the working fluid and associated spaces for housing the working fluid.

While LIVE system 200 is shown as comprising a single splash guard 224 having a single obstruction disc, in alternative embodiments, LIVE systems are contemplated that comprise a plurality of separately removable obstruction walls, whether disc-shaped or shaped differently. Importantly, a central facing obstruction surface of any splash guard contemplated herein should be located within a liquid zone of the LIVE system.

Still further, it will be appreciated that while LIVE systems 200 are shown and discussed being used in conjunction with helicopter 100 which has two LIVE systems 200, this disclosure contemplates use of one LIVE system 200 with aircraft or other systems, two LIVE systems 200 with aircraft or other systems, and three or more LIVE systems 200 with aircraft or other systems.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A liquid inertia vibration elimination (“LIVE”) system, comprising:
a first liquid zone;
a second liquid zone;
a plug at least partially segregating the first liquid zone from the second liquid zone, the plug comprising an aperture in fluid communication with the first liquid zone and the second liquid zone; and
a splash guard disposed within the second liquid zone and offset from the plug.

2. The LIVE system of claim 1, wherein the first liquid zone is adjacent a first gas zone.

3. The LIVE system of claim 1, wherein the second liquid zone is disposed within an accumulator.

4. The LIVE system of claim 1, wherein the splash guard comprises an obstruction disc.

5. The LIVE system of claim 1, wherein the splash guard comprises a mounting tube.

6. The LIVE system of claim 5, wherein the plug comprises a mounting hole axially aligned with the mounting tube.

7. The LIVE system of claim 1, wherein the splash guard is disposed along an axis of the aperture of the plug.

8. A splash guard for a liquid inertia vibration elimination (“LIVE”) system, comprising:
an obstruction disc.

9. The splash guard of claim 8, further comprising:
a mounting tube.

10. The splash guard of claim 9, wherein an aperture of the mounting tube is aligned with an aperture of the obstruction disc to accept a mounting bolt therein.

11. An aircraft, comprising:
a frame;
a transmission; and
a liquid inertia vibration elimination (“LIVE”) system coupled between the frame and the transmission, the LIVE system being configured to attenuate communication of vibrations from the transmission to the frame, the LIVE system, comprising:
a first liquid zone;
a second liquid zone;
a plug at least partially segregating the first liquid zone from the second liquid zone, the plug comprising an aperture in fluid communication with the first liquid zone and the second liquid zone; and
a splash guard disposed within the second liquid zone and offset from the plug.

12. The LIVE system of claim 11, wherein the first liquid zone is adjacent a first gas zone.

13. The LIVE system of claim 11, wherein the second liquid zone is disposed within an accumulator.

14. The LIVE system of claim 11, wherein the splash guard comprises an obstruction disc.

15. The LIVE system of claim 11, wherein the splash guard comprises a mounting tube.

16. The LIVE system of claim 15, wherein the plug comprises a mounting hole axially aligned with the mounting tube.

17. The LIVE system of claim 11, wherein the splash guard is disposed along an axis of the aperture of the plug.
